(19) United States
(12) Patent Application Publication
(10) Pub. No.: US 2015/0295261 A1
(43) Pub. Date: Oct. 15, 2015

(54) FUEL CELL SYSTEM COMPRISING A COMBINED FUEL PROCESSING APPARATUS AND A FUEL CELL UNIT

(71) Applicant: Haldor Topsøe A/S, Kgs. Lyngby (DK)

(72) Inventor: Hassan Modarrresi, Lyngby (DK)

(21) Appl. No.: 14/443,247

(22) PCT Filed: Nov. 21, 2012
(86) PCT No.: PCT/EP2012/073246

§ 371 Date: May 15, 2015

(51) Int. Cl. H01M 8/06; H01M 8/04

(52) U.S. Cl. CPC H01M 8/0675; H01M 8/0618; H01M 8/04223

(57) ABSTRACT

The invention concerns a fuel cell system comprising a fuel processing apparatus, said apparatus including: (a) a sulfur resistant fuel processing (SRFP) unit, (b) a steam reforming (STR) unit, (c) a sulfur removal/hydrogen enrichment (SRHE) unit, (d) a hydro-desulfurisation (HDS) unit and optionally (e) a hydrogen purification (HYP) unit, and either a low/medium temperature or a high temperature fuel cell unit. The hydrogen purification (HYP) unit (e) works most beneficially when the fuel cell is a low/medium temperature fuel cell. Combining two different fuel processing units in a fuel cell system makes it possible to deal more effectively with the difficulties of processing sulfur-containing fuels.

The present invention concerns a fuel cell system comprising a combined fuel processing apparatus and a fuel cell unit. More specifically, the invention concerns a fuel cell system, which comprises a fuel processing apparatus including a sulfur resistant fuel processing unit, a steam reforming unit, a sulfur removal/hydrogen enrichment unit, a hydro-desulfurisation unit and optionally a hydrogen purification unit, and either a low/medium temperature or a high temperature fuel cell unit. The hydrogen purification unit is most beneficial when the fuel cell is a low/medium temperature fuel cell.

Dealing with a sulfur-containing fuel (especially liquid logistic fuel) in a fuel cell system is not an easy task for fuel cell system development. Fuel processing units, which are able to convert a hydrocarbon fuel into a suitable feed gas for fuel cells, can be divided into two main categories.

Fuel processors belonging to the first category have a high resistance towards sulfur. However, these fuel processors usually operate at high temperatures in the presence of an oxidant. As a result of this mode of operation, part of the fuel is literally burnt instead of being available in the fuel cell system to produce electricity. Catalytic partial oxidation (CPO) processors, partial oxidation processors and plasma fuel processors are examples from this category.

Fuel processors belonging to the second category have a low resistance (or no resistance at all) towards sulfur. However, potentially all the fuel being fed to the system can be utilized in the fuel cell, whereby maximum system efficiency can be obtained. Steam reformers and pre-reformers, which usually operate at lower temperatures in the presence of steam, are examples from this category.

The present invention is based on the idea of combining two different fuel processing units in a fuel cell system in order to deal more effectively with the difficulties of processing sulfurous fuels. More specifically, an auxiliary fuel processing unit, being highly resistant towards sulfur but somewhat less efficient in a fuel cell system, is combined with a main fuel processing unit. Said main fuel processing unit may be vulnerable in the presence of sulfur, yet highly efficient in the fuel cell system.

Thus the invention concerns a fuel cell system comprising a fuel processing apparatus, said apparatus including:
(a) a sulfur resistant fuel processing (SRFP) unit,
(b) a steam reforming (STR) unit,
(c) a sulfur removal/hydrogen enrichment (SR-HE) unit,
(d) a hydro-desulfurisation (HDS) unit and optionally
(e) a hydrogen purification (HYP) unit,

and either a low/medium temperature or a high temperature fuel cell unit, the hydrogen purification (HYP) unit (e) being most beneficial when the fuel cell is a low/medium temperature fuel cell.

Various fuel cell systems are known from the prior art. In US 2004/0131912 A1 a process is described, in which the hydrogen-lean anode exhaust gas is enriched in a hydrogen enriching unit, such as a pressure swing adsorption (PSA) unit. The enriched gas is then recycled to the fuel cell, which includes two anode compartment types. The first one, being resistant towards carbon deposition, yet active for direct hydrogen oxidation, receives hydrocarbon fuel mixed with recycled hydrogen-rich gas. Hydrogen is consumed in this compartment to generate electricity. As a result, steam is generated. The generated steam is used in the second anode compartment, which is active for steam reforming, to generate further hydrogen and hence electricity. The application is mainly focused on the cell and stack layout. It tries to utilize the unused hydrogen from the fuel cell by enriching it and recycling to the fuel cell. There is no intention in dealing with sulfurous fuels, which is the main focus of the idea underlying the present invention. Furthermore, it explains how to utilize unused oxygen from the cathode in a fuel cell which uses pure oxygen in the cathode part. The exhaust oxygen from the cathode is used in a partial oxidation unit to produce syngas.

US 2005/0081444 A1 focuses on catalytic partial oxidation (CPO) design and on improving its performance by heat integration. The application barely touches upon the system design and system configuration issues. Furthermore, no part of the application addresses any sulfurous fuel issues.

US 2005/0164051 A1 concerns a high temperature fuel cell system and a method of operating it. The application describes the idea of enriching the gas with hydrogen and feeding it to the desulfurizer unit. However, the source of hydrogen for this purpose is different from the system of the present invention where an auxiliary CPO unit is used to produce hydrogen-containing gas. Contrarily, in this US application a combustion unit is used to generate heat, which is transferred to the reformer. Finally hydrogen-containing gas is produced in the reformer. In general, this US application is silent as regards utilizing two fuel processing (reforming) units in parallel.

In US 2007/0122339 a novel way of producing hydrogen via a hybrid conventional fuel reforming is explained. The reforming unit is followed by a high and a low temperature shift unit and an electrolyzing unit which splits steam into hydrogen and oxygen, whereby a small fraction of generated oxygen is used in a preferential oxidation unit downstream of the low temperature shift, whereby the remaining carbon monoxide is converted to carbon dioxide. The resulting gas mixture of carbon dioxide, water and hydrogen is treated to separate hydrogen as the final product. The system in itself can be used as a hydrogen gas generating unit to provide the required hydrogen for the hydro-desulfurisation unit. However, for economical reasons, this is definitely not an attractive solution for fuel cells.

The most pertinent prior art appears from US 2008/0102328 A1, which describes a fuel processor for a fuel cell arrangement and a method of operating said fuel processor. The fuel processor according to this US application can supply “safe gas” (a combination of synthesis gas, oxygen-depleted gas and steam) to the fuel cell arrangement in a first mode of operation, synthesis gas to the fuel cell arrangement in a second mode of operation and a hydrocarbon fuel to the fuel cell arrangement in a third mode of operation. The first mode is start-up and shut-down conditions of the fuel cell arrangement, the second mode is hot idle and/or part load conditions of the fuel cell arrangement and the third mode is normal conditions of the fuel cell arrangement. The fuel processor includes a mandatory combustor to supply oxygen-depleted air and steam to the prereformer in the first mode of operation. Said first mode of operation comprises desulfurising a hydrocarbon fuel, carrying out catalytic partial oxidation (CPO) on the desulfurised hydrocarbon fuel to produce a synthesis gas, burning the desulfurised hydrocarbon fuel to produce oxygen-depleted gas and mixing the synthesis gas with the oxygen-depleted gas to produce safe gas. The fuel processing apparatus according to the present invention does not require a combustor.

While the patent claims of US 2008/0102328 A1 are rather broad, the system layout of said application is practically only applicable to fuel cell systems based on natural gas. This fact is clearly reflected by the examples. In contrast hereto, the present invention is practically applicable to any system based on liquid fuel, such as a logistic fuel, diesel, ultra-low sulfur diesel (ULSD) or liquefied petroleum gas (LPG). In fact the present invention aims at dealing with any sulfur-containing liquid fuel.

During start-up and shut-down conditions of the fuel cell arrangement according to the above US 2008/0102328 A1, a mixture of syngas and burnt fuel is used for pre-heating the system components, whereas in the fuel cell system according to the invention the outlet gas from the sulfur removal/hydrogen enrichment (SR-HE) unit or the hydrogen purification (HYP) unit is used.

In the following the fuel cell system according to the invention, which consists of a fuel processing apparatus and a fuel cell unit, will be described in more detail with reference to the drawings, in which

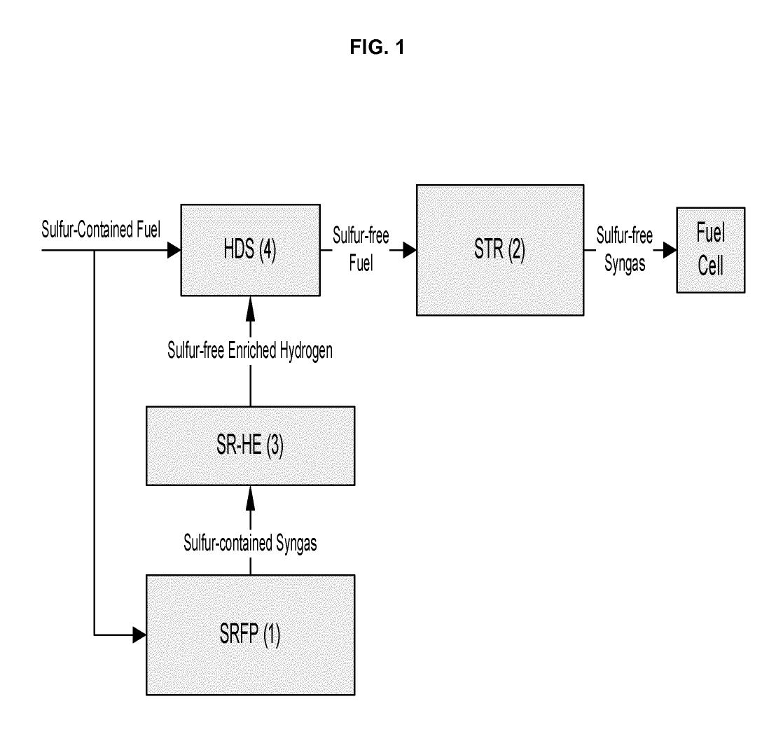

FIG. 1 shows a high temperature fuel cell system, where the fuel cell unit is a single solid oxide fuel cell (SOFC), an SOFC stack or modules or groups of many stacks,

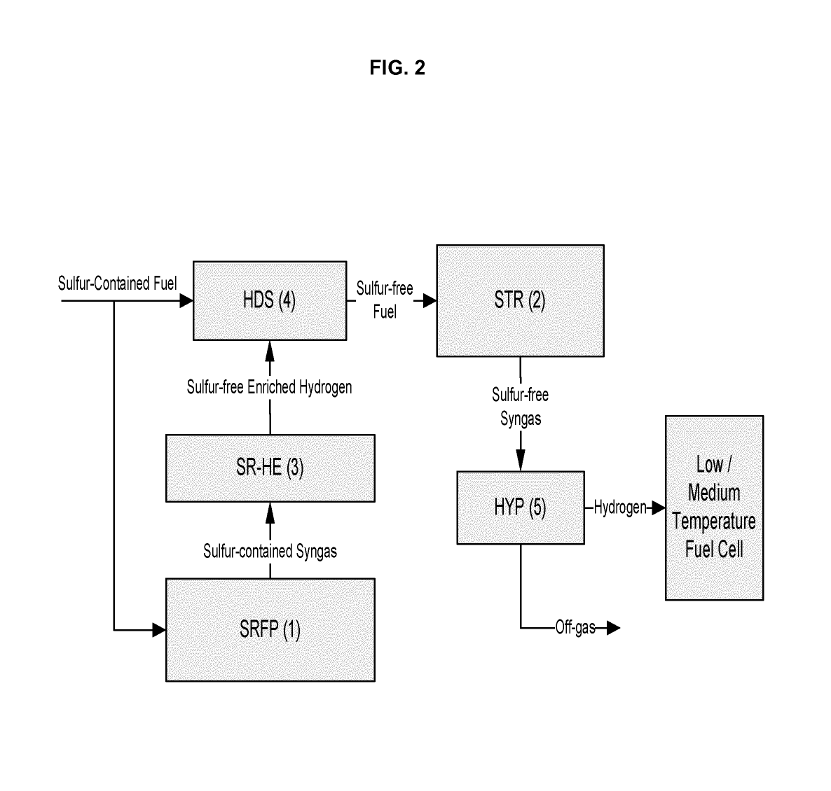

FIG. 2 shows a low/medium temperature fuel cell system, and

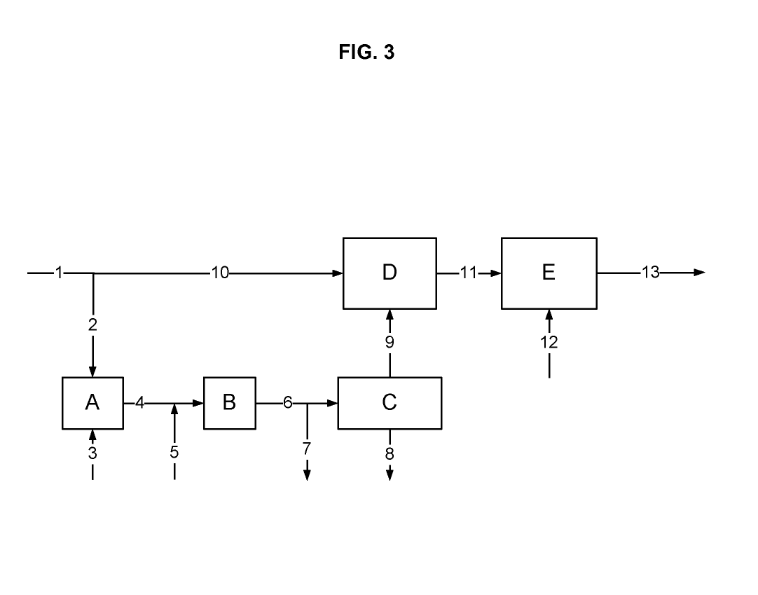

FIG. 3 is an illustration of the fuel cell system of the invention described in the example.

The fuel cell system according to the invention comprises a fuel processing apparatus, said apparatus including
(a) a sulfur resistant fuel processing (SRFP) unit (1),
(b) a steam reforming (STR) unit (2),
(c) a sulfur removal/hydrogen enrichment (SR-HE) unit (3),
(d) a hydro-desulfurisation (HDS) unit (4) and optionally
(e) a hydrogen purification (HYP) unit (5),

and either a low/medium temperature or a high temperature fuel cell unit, the hydrogen purification (HYP) unit (e) being most beneficial when the fuel cell is a low/medium temperature fuel cell.

As already mentioned, the present invention is based on the idea of combining two different fuel processing units in a fuel cell system in order to deal more effectively with the difficulties encountered when processing sulfur-containing fuels. More specifically, an auxiliary fuel processing unit (1), being highly resistant towards sulfur but somewhat less effective in a fuel cell system, is combined with a main fuel processing unit (4). Said main fuel processing unit may be vulnerable in the presence of sulfur, yet it is highly efficient in the fuel cell system.

As mentioned above, the sulfur resistant fuel processing unit 1 is an auxiliary unit which needs to generate enough hydrogen for the hydro-desulfurisation (HDS) unit 4 and possibly also for start-up and shut-down of the system.

The relative size of the main fuel processing unit to the auxiliary fuel processing unit is rather large in order to gain benefits in terms of system efficiency.

A small fraction of the sulfur-containing fuel is fed to the auxiliary fuel processing unit (1) to generate syngas. The product gas is further treated in a sulfur removal and hydrogen enrichment unit (3) to produce a hydrogen-enriched stream. Pressure swing adsorption (PSA), chemical absorption or adsorption combined with water gas shift units to remove carbon species are examples of hydrogen enrichment processes for syngas production. Conventional sulfur chemisorption agents, such as zinc oxide, can be used for the removal of sulfur species, mainly hydrogen sulfide.

The hydro-desulfurisation (HDS) unit (4) is preferably either a close-to-atmospheric pressure or a high pressure hydro-desulfurisation unit (operating at a pressure of 5-60 barg, preferably 20-40 barg) comprising a sulfur hydrogenation part and a part for removal of hydrogenated sulfur. The hydro-desulfurisation (HDS) unit can also be a unit operating at pressures between atmospheric pressure and high pressures.

The sulfur-free, hydrogen-enriched and optionally dried gas is used in the main fuel clean-up, more specifically for sulfur cleaning using conventional hydro-desulfurisation techniques. Clean fuel can then be converted into fuel cell feed gas in a highly effective fuel processing unit, such as a steam pre-reformer.

The main advantage of this embodiment is a higher efficiency of the fuel cell system, even with sulfur-containing fuels. Yet another, but certainly not less important, advantage is the easiness of the system start-up, standby, emergency shut-down and shut-down due to the availability of high temperature hydrogen-enriched gas.

The invention is illustrated further in the following non-limiting example.

### EXAMPLE

This example illustrates typical data for the fuel processing part of a fuel cell system according to the present invention. With reference to FIG. 3, the fuel processing part of the system comprises the following units:

A: a catalytic partial oxidation (CPO) unit,

B: a low temperature shift unit,

C: a hydrogen-rich gas separation unit,

D: a hydro-desulfurisation (HDS) unit and

E: a steam pre-reforming unit.

The streams of the system contain the following:

Stream no. 1, 2 and 10: logistic fuel

Stream no. 3: air

Stream no. 4: CPO syngas

Stream no. 5 and 7: water

Stream no. 6: shifted syngas

Stream no. 8: purge gas

Stream no. 9: hydrogen-rich gas

Stream no. 11: sulfur-free logistic fuel

Stream no. 12: steam (or anode recycle gas)

Stream no. 13: SOFC fuel gas

The following data apply for the system:

S/C ratio for pre-reforming: 2

O/C ratio for CPO: 1

Shift steam/CO: 1.2

CPO air compressor load: 2.1 kW

Inlet fuel LHV (lower heating value): 369 kJ/s

System net electrical power: 200 kW

System net efficiency: 54.2%

H2/fuel in HDS: 50 (for an S-content up to 3000 ppm).

The units A, B, C and D are each operated under a pressure of about 40 barg, while the unit E is operated at atmospheric pressure.

The logistic fuel has an approximate molecular weight around 200.

In Table 1 below the physical data and compositions are summarized for the streams 1-13.

TABLE 1

| | Stream | | | | | | |
|---|---|---|---|---|---|---|---|
| | 1 | 2 | 3 | 4 | 5 | 6 | 7 |
| T (° C.) | 25 | 25 | 25 | 980 | 25 | 220 | 50 |
| Flow | 30.9 | 0.98 | — | — | 1.2 | — | 0.3 |
| (kg/h) | | | | | | | |
| Flow | — | — | 3.7 | 5.7 | — | 7.2 | — |
| (Nm³/h) | | | | | | | |

Mole %

| | | | | | | | |
|---|---|---|---|---|---|---|---|
| Fuel | 100 | 100 | 0.0 | 0.0 | 0.0 | 0.0 | 0.0 |
| (mw~200) | | | | | | | |
| Air | 0.0 | 0.0 | 100 | 0.0 | 0.0 | 0.0 | 0.0 |
| Hydrogen | 0.0 | 0.0 | 0.0 | 19.5 | 0.0 | 33.3 | 0.0 |
| CO | 0.0 | 0.0 | 0.0 | 23.9 | 0.0 | 0.9 | 0.0 |
| CO₂ | 0.0 | 0.0 | 0.0 | 1.2 | 0.0 | 18.9 | 0.0 |
| Methane | 0.0 | 0.0 | 0.0 | 2.9 | 0.0 | 2.3 | 0.0 |
| Nitrogen | 0.0 | 0.0 | 0.0 | 50.3 | 0.0 | 39.6 | 0.0 |
| Argon | 0.0 | 0.0 | 0.0 | 0.6 | 0.0 | 0.5 | 0.0 |
| H₂O | 0.0 | 0.0 | 0.0 | 1.6 | 100 | 4.7 | 100 |

Stream

| | 8 | 9 | 10 | 11 | 12 | 13 |
|---|---|---|---|---|---|---|
| T (° C.) | 50 | 50 | 25 | 500 | 500 | 460 |
| Flow | — | — | 29.9 | — | — | — |
| (kg/h) | | | | | | |
| Flow | 3.8 | 3.1 | — | 6.9 | 98.2 | 135 |
| (Nm³/h) | | | | | | |

Mole %

| | | | | | | |
|---|---|---|---|---|---|---|
| Fuel | 0.0 | 0.0 | 100.0 | 62.3 | 0.0 | 0.0 |
| (mw~200) | | | | | | |
| Air | 0.0 | 0.0 | 0.0 | 0.0 | 0.0 | 0.0 |
| Hydrogen | 10.2 | 64.7 | 0.0 | 21.8 | 0.0 | 17.2 |
| CO | 1.4 | 0.3 | 0.0 | 0.1 | 0.0 | 0.7 |
| CO₂ | 14.9 | 25.7 | 0.0 | 11.6 | 0.0 | 13.7 |
| Methane | 3.9 | 0.5 | 0.0 | 0.2 | 0.0 | 22.1 |
| Nitrogen | 68.3 | 8.6 | 0.0 | 3.9 | 0.0 | 0.2 |
| Argon | 0.8 | 0.2 | 0.0 | 0.1 | 0.0 | 0.0 |
| H₂O | 0.6 | 0.0 | 0.0 | 0.0 | 100 | 46.1 |

1. A fuel cell system comprising a combined fuel processing apparatus, said apparatus including:
(a) an auxiliary sulfur resistant fuel processing unit,
(b) a main steam reforming unit,
(c) a sulfur removal/hydrogen enrichment unit,
(d) a hydro-desulfurisation unit and optionally
(e) a hydrogen purification unit,
and either a low/medium temperature or a high temperature fuel cell unit, the hydrogen purification unit being most beneficial when the fuel cell unit is a low/medium temperature fuel cell unit.

2. Fuel cell system according to claim 1, wherein the fuel cell unit is a high temperature fuel cell unit.

3. Fuel cell system according to claim 1, wherein the fuel cell unit is a low/medium temperature unit.

4. Fuel cell system according to claim 1, wherein the SRFP unit is a syngas generator selected from the group consisting of a catalytic partial oxidation reformer, a partial oxidation reformer, an autothermal reformer and a plasma reformer, said unit receiving a fraction of the total amount of fuel supplied to the system, which is sufficient to produce the hydrogen needed for deep desulfurisation of fuel in the steam reforming unit.

5. Fuel cell system according to claim 1, wherein the sulfur resistant fuel processing unit, the steam reforming unit and the hydro-desulfurisation unit all operate at an elevated pressure for an effective HDS function.

6. Fuel cell system according to claim 1, wherein the sulfur removal/hydrogen enrichment unit is used to separate a hydrogen-enriched stream for an effective deep desulfurisation of liquid fuel.

7. Fuel cell system according to claim 1, wherein the fuel is a liquid hydrocarbon cut, such as a logistic fuel, diesel, ultra-low sulfur diesel or liquefied petroleum gas.

8. Fuel cell system according to claim 1, wherein the hydro-desulfurisation unit is a close-to-atmospheric pressure hydro-desulfurisation unit.

9. Fuel cell system according to claim 1, wherein the hydro desulfurisation unit is a high pressure hydro-desulfurisation unit operating at a pressure of 5-60 barg, comprising a sulfur hydrogenation part and a part for removal of hydrogenated sulfur.

10. A method for system start-up and shut-down, wherein the outlet gas from the sulfur removal/hydrogen enrichment unit or the hydrogen purification unit is used for pre-heating the system components.

11. Method according to claim 10, wherein the relative size or load of the catalytic partial oxidation reformer or the sulfur removal unit is calculated such that the reformer supplies just enough hydrogen to the hydro-desulfurisation unit during system operation or start-up/shut-down of the system.
